(19) United States
(12) Patent Application Publication
(10) Pub. No.: US 2025/0042246 A1
(43) Pub. Date: Feb. 6, 2025

(54) Systems and Methods for Regulating the use of Carbon Neutral Fuels in regulated Vehicles

(71) Applicant: Infinium Technology, LLC, Sacramento, CA (US)

(72) Inventors: Robert Schuetzle, Sacramento, CA (US); Daphne Foley, Maricopa, AZ (US); Harold Wright, Menomonee Falls, WI (US); Benjamin Wright, Brookfield, WI (US)

(21) Appl. No.: 18/445,360

(22) Filed: Jul. 31, 2023

(51) Int. Cl. B60K 15/04

(52) U.S. Cl. CPC B60K 15/04; B60K 2015/03361

(57) ABSTRACT

The current invention is a method of regulating the use of cnFuels-CO2 Neutral Fuels (cnFuels)—in regulated compatible cnVehicles, comprising preventing an cnVehicle from being fueled with petFuel, and/or preventing an cnVehicle from being fueled from a HEFA based biofuel or from petroleum-based fuel. Physical means comprises physical incompatibility between a petFuel pump nozzle and an cnVehicle fuel inlet, where physical incompatibility comprises at least one of different shape; size; taper; curvature; plugs; and/or locks. Electronic means of preventing an cnVehicle from being fueled with petFuel comprises detecting at least one of: a petFuel pump; a petFuel pump nozzle; a petFuel station, a petFuel supplier data system, an cnFuel pump; an cnFuel pump nozzle; an cnFuel station, an cnFuel supplier data system, an electronic communication identifying an cnVehicle; an electronic communication identifying an cnVehicle operator; and/or an electronic communication identifying an cnFuel user.

### FIELD

The present invention is generally directed to systems and methods for ensuring the use of carbon neutral fuels (“cnFuels”) in vehicles which are under regulatory requirements to use cnFuels.

### BACKGROUND

Carbon dioxide is produced by many industrial and biological processes. Carbon dioxide is usually discharged into the atmosphere. However, since carbon dioxide has been identified as a significant greenhouse gas, carbon dioxide emissions need to be reduced from these processes. One such industrial process is the production of electrical power. Electrical power is increasingly being produced from renewable sources such as solar and wind which do not emit CO2 and can sometimes be produced more cost effectively than power produced from fossil fuels.

However, while electrical power can be produced in a sustainable manner, there remains a need for fuels and chemicals that are produced with low, zero or negative CO2 emissions. In some cases, this need can be fulfilled using cnFuels (synthetic fuels) that are made by storing electrical energy from renewable sources in the chemical bonds of liquid or gas molecules. cnFuels (electrofuels) are renewable fuels of non-biological origin, such as fuel molecules made from atmospheric CO2. They include Infinium eSAF™ aircraft fuel, Infinium eDiesel™, Infinium eGasoline™, and Infinium eNaptha™. cnFuels may also include other fuels as defined below. cnFuels can be used in vehicles without modification of the vehicle. cnFuels typically have very low levels of contaminants such as sulfur or metals. petFuels are fuel molecules derived from biological sources such as fossil fuels, for example petroleum and fossil natural gas. Biofuels such as HEFA based biofuels and biodiesel are of biological origin and are included in the definition of petFuels for the purposes of the present application.

cnFuels can be a drop-in alternative to aviation (e.g., jet) fuel, diesel fuel, gasoline, butanol, naphtha, synthetic natural gas, or other fuel products that are otherwise produced from fossil fuels (petFuels). Furthermore, potential chemicals that can be produced using renewable power include ammonia, methanol, as well as high value-added chemicals such as formaldehyde, acetic acid, acetic aldehyde, or lower olefins and aromatic compounds (e.g., as starting materials for fine chemical production). This category of cnFuel production processes can be referred to as “Power to X”, referring to renewable power being a primary input in producing X, where X is fuels, chemicals, natural gas, and the like.

Production of cnFuels and chemicals requires a feedstock in addition to electrical power. In some cases, this feedstock can include carbon, e.g., derived from CO2 captured from other industrial sources, which CO2 would otherwise be emitted into the atmosphere. In some cases, this feedstock can include nitrogen derived from several sources including air separation units. Some cnFuels or chemicals can be “carbon-negative”, i.e., consuming more CO2 than they emit in their production process. Water can be another feedstock to an cnFuel or chemical process, which can be electrolyzed using renewable power to produce oxygen (O2) and hydrogen (H₂).

cnFuel production using Power to X utilizes renewable power as a primary input and therefore this input comprises the largest part of the operating expense of an cnFuels or other Power to X plant. A secondary cost may be additional feedstocks, such as CO2, nitrogen, or other inputs.

Due to the low carbon emissions of cnFuels, cnFuels are highly desirable for lowering the carbon footprint of vehicles, especially heavy transport vehicles. While commuter cars are slowly converting to electrical batteries, heavy transport cannot easily do so. Heavy transport requires high power, and/or long-distance capability, that batteries are not expected to be able to provide in the foreseeable future. Replacing the engines on aircraft and other million-dollar heavy transport vehicles is also cost-prohibitive.

Heavy transport vehicles include airplanes (with JET A, where sustainable fuels are called Sustainable Aviation Fuel); trains (use diesel fuel); long haul trucks/agricultural equipment (use diesel fuel); automobiles for long distance travel (use gasoline or diesel fuel); and ships (use diesel fuel). In addition, stationary heavy machinery that uses gasoline or diesel, such as pumps, drills, generators, boilers, etc, is included in the definition of heavy transport for the purposes of this application.

cnVehicles are vehicles that are required by regulation to use cnFuels. These regulations are typically part of environmental initiatives, laws, and treaties. A vehicle may be sold as or designated as an cnVehicle in order to meet regulatory requirements. A vehicle may be designated as an cnVehicle on a permanent or temporary basis.

cnFuels emit only biogenic CO2 or recycled CO2 when burned, resulting in circular CO2 emissions and a net-zero or near net-zero impact on the climate. cnFuels are a direct, high quality, drop-in replacement for petFuels. cnFuels mean a renewable and/or synthetic fuel as defined under certain regulations, including Directive (EU) 2018/2001. cnFuels may include Renewable Fuels of Non Biological Origin (RFNBOs) also referred to as electrofuels or e-fuels. cnFuels may also include biofuels, biogas, biomass fuel, renewable liquid and gaseous transport fuels or recycled carbon fuels (RCF). cnFuels have near net-zero, net zero or negative CO2 emissions during use indicating that the CO2 equivalent of the carbon contained in the fuels chemical composition is biogenic in origin or has been prevented from being released into the atmosphere. Other renewable and/or synthetic fuels that satisfy these conditions and other sustainability criteria that may be defined in regulations, including Directive (EU) 2018/2001 and associated requirements including delegated acts, may also fulfil these definitions.

No or minimal engine modifications are required for a vehicle to use a cnFuel. This is convenient, but it is also a problem, because cnVehicles can use both petFuels and cnFuels. There is an unmet need for a way to ensure that cnVehicles are using cnFuels in accordance with climate-protection regulations.

The European Commission has agreed to propose a legal route to exempt cars that run on cnFuels from the EU's 2035 phaseout of new combustion engine vehicles. In fact, the European Commission agreed to create a new vehicle category for vehicle models that can only run of cnFuels. Vehicles running on eFuel in Europe will require new technology to prevent them from using gasoline or diesel.

### SUMMARY OF THE INVENTION

The current invention is a method of enforcing the use of cnFuels in regulated cnVehicles, comprising the step of preventing an cnVehicle from being fueled with a prohibited fuel chosen from a group comprising petFuel, HEFA-based fuel, and other high carbon fuels by physical and/or electronic means.

High carbon fuels include petroleum, diesel, aviation fuel, hydrotreated vegetable oils (HVO), and hydroprocessed esters and fatty acids (HEFA). These fuels are all derived from biological sources, with petroleum being a fossilized biological fuel.

In one aspect, a method of enforcing the use of cnFuels in regulated cnVehicles is presented. The method comprises preventing an cnVehicle from be fueled with petFuel by physical and/or electronic methods. A nonlimiting example of a physical method includes the physical incompatibility between a petFuel pump nozzle and an cnVehicle fuel inlet. The physical incompatibility can be, for example, at least one of shape, size, taper, curvature, plugs, and/or locks.

A non-limiting example of an electronic method includes detecting at least one of: a petFuel pump; a petFuel pump nozzle; a petFuel station, a petFuel supplier data system, an cnFuel pump; an cnFuel pump nozzle; an cnFuel station, an cnFuel supplier data system, an electronic communication identifying an cnVehicle; an electronic communication identifying an cnVehicle operator; and/or an electronic communication identifying an cnFuel user.

The electronic method of preventing an cnVehicle from being fueled with petFuel comprises: at least one electronic communication between said petFuel pump or petFuel nozzle, and said cnVehicle. The at least one electronic communication between the petFuel pump or petFuel nozzle, and said cnVehicle comprises at least one of: close proximity electronic communication; internet/ranged electronic communication; passcard/RFID electronic communication; and/or optical electronic communication, preferably barcode or Qcode.

In another aspect, a method of physically enforcing the use of cnFuels in regulated vehicles is provided. The method comprises providing an cnFuel pump outlet that is compatible with an cnVehicle fuel inlet, wherein said cnVehicle fuel inlet is not compatible with a traditional petFuel outlet.

In another aspect, the cnVehicle fuel inlet comprises an opening shaped to prevent the correct entry and/or placement of a traditional nozzle of a petFuel dispensing pump, such as nozzles currently used throughout the world to dispense gasoline, diesel, aviation fuel, and/or other fuels into vehicles. A modern fuel dispenser is logically divided into two main part—an electronic “head” containing an embedded computer to control the action of the pump, drive the pump's displays, and communicate to an indoor sales system; and secondly, the mechanical section which in a “self contained” unit has an electric motor, dispensing pump, meters, pulsers and valves to physically pump and control the fuel flow. Traditional nozzles used to dispense “unleaded gasoline” should have a nominal OD of 20.6 mm (13/16 in) and be straight for 85 to 95 mm (3.35 to 3.74 in) from the outlet. It is understood that tolerances and normal use may increase the spout up to 21.3 mm (0.84 in) OD. The traditional nozzles for all other fuels should have a nominal OD of 23.8 mm (15/16 in) or more. Tolerances may decrease these spouts to 23.6 mm (0.93 in) OD.

In some cases, the cnVehicle fuel inlet opening comprises an inlet shape cross section that is incompatibly sized and/or incompatibly shaped with the cross-section shape of said nozzle of a traditional petFuel dispensing pump. For instance, the cnVehicle fuel inlet shape cross section comprises a square hole and the traditional petFuel dispensing pump nozzle is a round peg. The cnVehicle fuel inlet shape cross section may comprise a shape and the traditional petFuel dispensing pump nozzle shape cross section is a larger shape. In other cases, the cnVehicle fuel inlet opening comprises an inlet curvature that is more curved and/or incompatibly curved with the curved shape of said nozzle of a traditional petFuel dispensing pump.

In some cases, the cnVehicle fuel inlet opening comprises a multi-lumen shape that is incompatible with the shape of the nozzle of a traditional petFuel dispensing pump. The cnVehicle fuel inlet opening may comprise an inlet taper that is incompatible with the shape of the nozzle of a traditional petFuel dispensing pump. Or, the cnVehicle fuel inlet and said traditional petFuel dispensing pump nozzle may be of incompatible lengths.

In another case, the cnVehicle fuel inlet comprises a housing, and the housing comprises a data link plug configured to receive the matching data link plug on an cnFuel dispenser nozzle. The cnVehicle fuel inlet may comprise a housing, wherein the housing comprises a keyed shape configured to receive a compatible keyed shape on an cnFuel dispenser nozzle. The keyed shape may be an annular ring of teeth configured to receive a compatible annular ring of teeth on an cnFuel dispenser nozzle.

### BRIEF DESCRIPTION OF THE DRAWINGS

FIG. 1 is a diagram of preventing an cnVehicle from being fueled with petFuel by physical or electronic gatekeeping.

FIG. 2 is a diagram of preventing an cnVehicle from being fueled with petFuel by various electronic means of gatekeeping.

FIG. 3a is a diagram of allowing an cnVehicle to be fueled with eFuel by various physical means of gatekeeping between the cnVehicle fuel inlet, and the eFuel nozzle.

FIG. 3b is a perspective view of an cnVehicle fuel inlet and an cnFuel nozzle, wherein a physical data connection is made when the cnFuel nozzle fits into the cnVehicle fuel inlet.

FIG. 3c is a perspective view of an cnVehicle fuel inlet and an cnFuel nozzle, wherein a physical interlocking key or puzzle connection is made when the cnFuel nozzle fits into the cnVehicle fuel inlet.

FIG. 3d is a perspective view of an cnVehicle fuel inlet and an cnFuel nozzle, wherein the cnFuel nozzle fits into the cnVehicle fuel inlet. Preferably the cnVehicle fuel inlet has a smaller diameter than a traditional petFuel nozzle.

FIG. 3e is a perspective view of an cnVehicle fuel inlet and an cnFuel nozzle, wherein the cnFuel nozzle fits into the cnVehicle fuel inlet due to having the same taper and/or curvature. Preferably the cnVehicle fuel inlet has a different taper and/or curvature than a traditional petFuel nozzle.

FIG. 3f is a perspective view of an cnVehicle fuel inlet and an cnFuel nozzle, wherein the cnFuel nozzle fits into the cnVehicle fuel inlet due to having the same two-conduit shape.

FIG. 4a is a diagram of preventing an cnVehicle to be fueled with petFuel by various physical means of gatekeeping between the cnVehicle fuel inlet, and the petFuel nozzle.

FIG. 4b is a perspective view of an cnVehicle fuel inlet and a petFuel nozzle, wherein the cnFuel nozzle does not fit into the cnVehicle fuel inlet due to differing size and/or cross-sectional shape.

FIG. 4c is a perspective view of an cnVehicle fuel inlet and a petFuel nozzle, wherein the cnFuel nozzle does not fit into the cnVehicle fuel inlet because the cnVehicle fuel inlet has a smaller diameter than a traditional petFuel nozzle.

FIG. 4d is a perspective view of an cnVehicle fuel inlet and a petFuel nozzle, wherein the petFuel nozzle does not fit into the cnVehicle fuel inlet due to differing taper and/or curvature.

FIG. 4e is a perspective view of an cnVehicle fuel inlet and a petFuel nozzle, wherein the petFuel nozzle does not fit into the cnVehicle fuel inlet due to the cnVehicle fuel inlet having a two-conduit shape.

FIG. 4f is a perspective view of an cnVehicle fuel inlet and a petFuel nozzle, wherein a physical data connection is not made when the petFuel nozzle fits into the cnVehicle fuel inlet; therefore, fueling is prevented by the cnVehicle, and/or a fueling with petFuel is recorded.

### DETAILED DESCRIPTION OF THE INVENTION

A method 100 of tracking the use of cnFuels in cnVehicles is needed, so that regulations can be tracked and enforced. It is also important to track the use of cnFuels in petVehicles, so that overall cnFuel use can be tracked.

The inventive method involves at least one way of preventing an cnVehicle from being fueled with petFuel by physical or electronic means.

cnFuels (electrofuels) are renewable fuels of non-biological origin, such as fuel molecules made from atmospheric CO2. They include Infinium eSAF™ aircraft fuel, Infinium eDiesel™, Infinium eGasoline™, and Infinium eNaptha™ and other Infinium eFuels and eChemicals. cnFuels can also include other fuels as described herein. cnFuels can be used in vehicles without modification of the vehicle. cnFuels typically have very low levels of contaminants such as sulfur or metals. Biofuels such as HEFA based biofuels and biodiesel are of biological origin and are included in the definition of petFuels and high carbon fuels for the purposes of the present application.

High carbon fuels include petroleum, diesel, aviation fuel, hydrotreated vegetable oils (HVO), and hydroprocessed esters and fatty acids (HEFA). These fuels are all derived from biological sources, with petroleum being a fossilized biological fuel.

cnVehicles are vehicles that are required by regulation to use cnFuels. These regulations are typically part of environmental initiatives, laws, and treaties. A vehicle may be sold as or designated as an cnVehicle in order to meet regulatory requirements. A vehicle may be designated as an cnVehicle on a permanent or temporary basis.

An cnVehicle may be any designated vehicle that otherwise would use petroleum-based fuels (petFuels) such as gasoline, aviation fuel, and diesel. Planes (with JET A, also called Sustainable Aviation Fuel); trains (use diesel fuel); long haul trucks (use diesel fuel); agricultural equipment (use diesel fuel); construction equipment (use diesel fuel); busses (use diesel or gasoline); automobiles (use gasoline or diesel fuel); and ships (use diesel fuel) may be designated as cnVehicles. It is also contemplated that stationary heavy equipment such as generators, boilers, distillers, conveyor belts, drills, pumps, and cranes, etc. may be designated to use cnFuels and are included in the definition of cnVehicles for the purposes of the present application.

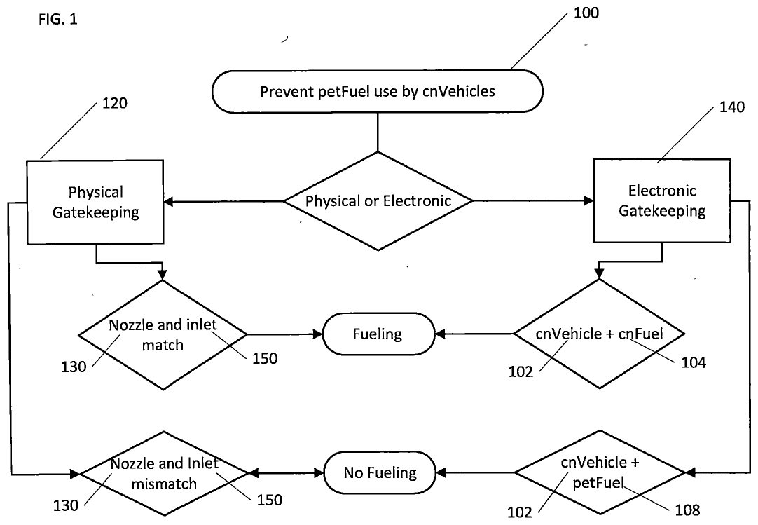

FIG. 1 is a diagram of method 100 of preventing an cnVehicle 102 from being fueled with petFuel 108 by physical gatekeeping 120 or electronic gatekeeping 140.

The electronic gatekeeping method 140 includes electronic means of preventing an cnVehicle 102 from being fueled with petFuel 108. This involves an cnFuel user 201 identifying 203 an cnFuel supplier 205, or vice versa, preferably before fueling. When an cnFuel user 201 identifies 203 a petFuel supplier 207, or vice versa, fueling is prevented or prohibited.

The physical gatekeeping method 120 includes physical methods of preventing an cnVehicle 102 from being fueled with petFuel 108. The physical means can be physical incompatibility between a fuel pump nozzle 130 and a vehicle fuel inlet 150, due to a mismatch of shape, size, plugs, size and shape, locks and/or other incompatible shapes that make it impossible for a fuel pump nozzle 130 to mate with a vehicle fuel inlet 150.

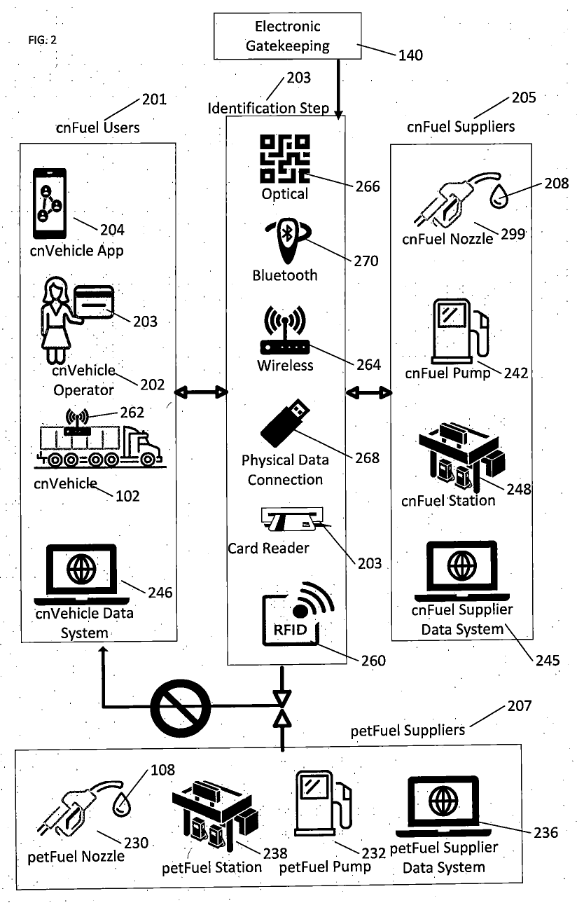

FIG. 2 is a diagram of preventing an cnVehicle 102 from being fueled with petFuel 108 by various electronic means of gatekeeping. The electronic gatekeeping method 140 includes electronic methods of preventing an cnVehicle 102 from being fueled with petFuel 108. The electronic methods include detecting 203 at least one of: a petFuel pump 232; a petFuel pump nozzle 230; a petFuel supplier data system 236; a petFuel station 238; and/or an electronic communication identifying an cnFuel user, such as an cnVehicle 102 and/or an cnVehicle operator 202, an cnVehicle data app 204, a cnFuel supplier data system 245, and/or an cnVehicle data system 246.

Detecting an electronic communication identifying an cnVehicle operator 202 involves detecting: a signal from an cnVehicle operator identification card 203; a signal from an cnVehicle operator RFID device 260; a signal from an cnVehicle identification tweeter 262; a signal from an cnVehicle operator cellular phone app 204. Collecting data from an cnVehicle includes collecting data from a non-removable cnVehicle data broadcast device such as cnVehicle identification tweeter 262; and/or at least one non-removable cnVehicle ID passive read data device such as an RFID 260. The non-removable cnVehicle data broadcast device can be cnVehicle identification tweeter 262, wireless internet 264, Bluetooth 270, radio, and/or infrared data transmission. Non-removable cnVehicle ID passive read data device comprises at least one of wireless internet 264, Bluetooth 270, RFID 260, barcode, Qcode 266, and a physical data connection 268.

When an cnFuel user 201 identifies 203 an cnFuel supplier 205, or vice versa, fueling is enabled or allowed.

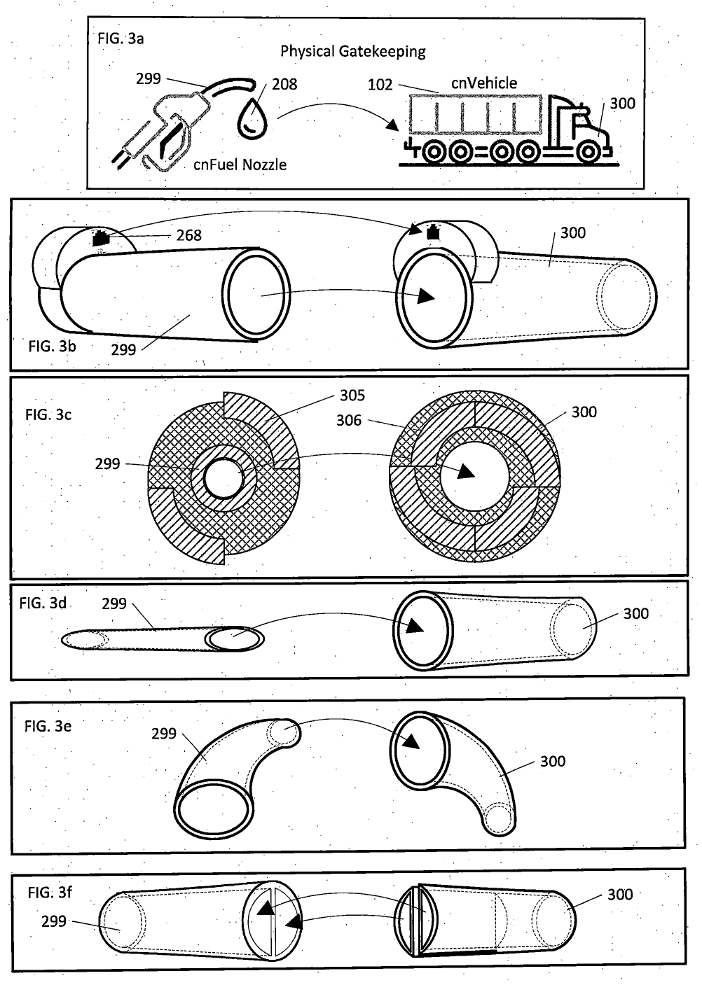

FIG. 3a is a diagram of allowing an cnVehicle 102 to be fueled with cnFuel 108 by various physical methods of gatekeeping between the cnVehicle fuel inlet 300, and the cnFuel nozzle 299. The physical means can be physical incompatibility between a fuel pump nozzle 130 and a vehicle fuel inlet 150, due to a mismatch of shape, size, plugs, size and shape, locks and/or other incompatible shapes that make it impossible for a fuel pump nozzle 130 to mate with a vehicle fuel inlet 150.

FIG. 3b is a perspective view of an cnVehicle fuel inlet 300 and an cnFuel nozzle 299, wherein a physical data connection 268 is made when the cnFuel nozzle 299 fits into the cnVehicle fuel inlet 300.

FIG. 3c is a perspective view of an cnVehicle fuel inlet 300 and an cnFuel nozzle 299, wherein a physical interlocking key or puzzle connection between parts 305 and 306 is made when the cnFuel nozzle 299 fits into the cnVehicle fuel inlet 300.

FIG. 3d is a perspective view of an cnVehicle fuel inlet 300 and an cnFuel nozzle 299, wherein the cnFuel nozzle 299 fits into the cnVehicle fuel inlet 300. Preferably the cnVehicle fuel inlet 300 has a smaller diameter than a traditional petFuel nozzle 230.

FIG. 3e is a perspective view of an cnVehicle fuel inlet 300 and an cnFuel nozzle 299, wherein the cnFuel nozzle 299 fits into the cnVehicle fuel inlet 300 due to having the same taper and/or curvature. Preferably the cnVehicle fuel inlet 300 has a different taper and/or curvature than a traditional petFuel nozzle 230.

FIG. 3f is a perspective view of an cnVehicle fuel inlet 300 and an cnFuel nozzle 299, wherein the cnFuel nozzle 299 fits into the cnVehicle fuel inlet 300 due to having the same multiple-conduit shape.

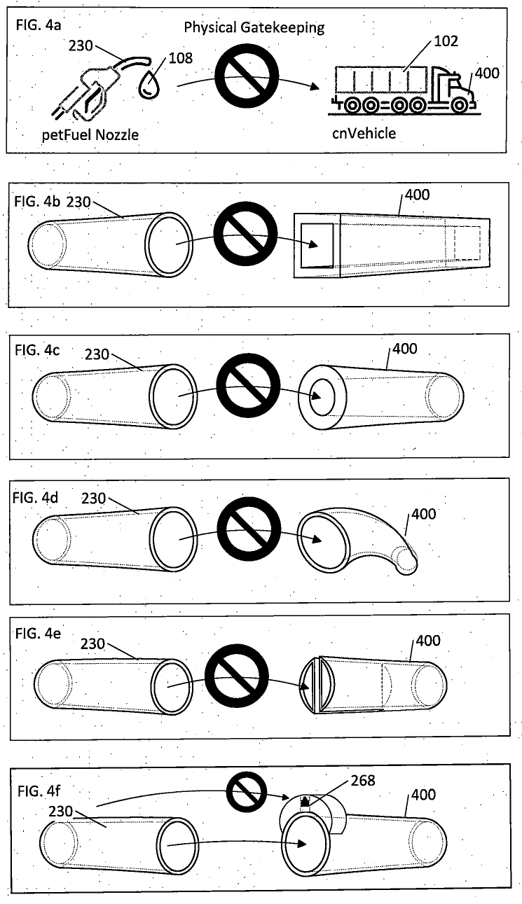

FIG. 4a is a diagram of preventing an cnVehicle 102 from being fueled with petFuel 108 by various physical methods of gatekeeping between the cnVehicle fuel inlet 400, and the petFuel nozzle 230. The method of physically enforcing the use of cnFuels 108 in regulated cnVehicles 102 can be the step of providing an cnFuel nozzle 102 that is compatible with an cnVehicle fuel inlet 400, wherein the cnVehicle fuel inlet 400 is not compatible with a traditional petFuel nozzle 230.

FIG. 4b is a perspective view of an cnVehicle fuel inlet 400 and a petFuel nozzle 230, wherein the petFuel nozzle 230 does not fit into the cnVehicle fuel inlet 400 due to differing size and/or cross-sectional shape.

FIG. 4c is a perspective view of an cnVehicle fuel inlet 400 and a petFuel nozzle 230, wherein the petFuel nozzle 230 does not fit into the cnVehicle fuel inlet 400 because the cnVehicle fuel inlet 300 has a smaller diameter than a traditional petFuel nozzle 230.

FIG. 4d is a perspective view of an cnVehicle fuel inlet 400 and a petFuel nozzle 230, wherein the petFuel nozzle 230 does not fit into the cnVehicle fuel inlet 400 due to differing taper and/or curvature.

FIG. 4e is a perspective view of an cnVehicle fuel inlet 400 and a petFuel nozzle 230, wherein the petFuel nozzle 230 does not fit into the cnVehicle fuel inlet 400 due to the cnVehicle fuel inlet 300 having a two-conduit shape.

FIG. 4f is a perspective view of an cnVehicle fuel inlet 400 and a petFuel nozzle 230, wherein a physical data connection 268 is not made when the petFuel nozzle 230 fits into the cnVehicle fuel inlet 400; therefore fueling is prevented by the cnVehicle 102, and/or a fueling with petFuel 108 is recorded.

1. A method of enforcing the use of cnFuels in regulated eVehicles, wherein the method comprises the step of preventing an cnVehicle from being fueled with petFuel through providing physical, physical and electronic, or electronic incompatibilities between a first element that delivers petFuel from a petFuel source and a second element in the cnVehicle that receives cnFuel.

2. The method of claim 1, wherein the step of preventing an cnVehicle from being fueled with petFuel comprises providing physical incompatibilities between the first element and the second element.

3. The method of claim 1, wherein the step of preventing an cnVehicle from being fueled with petFuel comprises electronic incompatibilities between the first element and the second element.

4. The method of claim 2, wherein physical incompatibilities between the first element and the second element consist of one or more of the following physical incompatibilities: incompatible shapes; incompatible sizes; incompatible tapers; incompatible curvatures; incompatible plugs; incompatible locks.

5. The method of claim 3, wherein electronic incompatibilities between the first element and the second element consist of one or more of the following electronic incompatibilities: an incompatible petFuel pump; an incompatible petFuel pump nozzle; an incompatible petFuel station; an incompatible petFuel supplier data system; an incompatible cnFuel pump; an incompatible cnFuel pump nozzle; an incompatible cnFuel station; an incompatible cnFuel supplier data system; an incompatible electronic communication identifying an cnVehicle; an incompatible electronic communication identifying an cnVehicle operator; an incompatible electronic communication identifying an cnFuel user.

6. The method of claim 3, wherein the electronic compatibilities between the first element and the second element comprise at least one electronic communication between the first element and the second element.

7. The method of claim 6, wherein the at least one electronic communication between the first element and the second element comprises one of the following electronic communications: close proximity electronic communication; internet or ranged electronic communication; passcard or RFID electronic communication; barcode or Qcode electronic communication.

8. A method of physically enforcing use of enFuels in regulated cnVehicles, wherein the method comprises providing an cnFuel pump fuel outlet that is compatible with an cnVehicle fuel inlet, and wherein the cnVehicle fuel inlet is incompatible with petFuel fuel outlets.

9. The method of claim 8, wherein the cnVehicle fuel inlet comprises an opening shaped to prevent entry or placement of petFuel outlets.

10. The method of claim 8, wherein the cnVehicle fuel inlet comprises a housing, and wherein the housing comprises a data link plug configured to receive a matching data link plug on the petFuel outlets.

11. The method of claim 8, wherein the cnVehicle fuel inlet comprises a housing, and wherein the housing comprise a first keyed shape, and wherein the petFuel outlets comprise a second keyed shape, and wherein the first keyed shape and the second keyed shape are compatible in that they fit together.

12. The method of claim 9, wherein the cnVehicle fuel inlet has a first cross section, and wherein petFuel outlets have a second cross section, and wherein the first cross section is incompatibly sized or shaped in relation to the second cross section.

13. The method of claim 10, wherein the first cross section comprises a square hole, and wherein the second cross section comprises a round outlet.

14. The method of claim 10, wherein the first cross section and second cross section are incompatibly sized.

15. The method of claim 10, wherein the first cross section and second cross section are incompatibly shaped, and wherein they are incompatibly shaped as the result of different curvatures.

16. The method of claim 10, wherein the first cross section and second cross sectio. are incompatibly shaped, and wherein they are incompatibly shaped as the result of different tapers.

17. The method of claim 10, wherein the first cross section and second cross section are incompatibly sized, and wherein they are incompatibly sized as the result of different lengths.

18. The method of claim 11, wherein the first keyed shape is an annular ring of teeth configured to receive the second keyed shape, wherein the second keyed shape is a compatible ring of teeth.
